(19) United States
(12) Patent Application Publication
(10) Pub. No.: US 2015/0158434 A1
(43) Pub. Date: Jun. 11, 2015

(54) REMOTE SYSTEM AND METHOD FOR CONTROLLING A VEHICLE DEVICE

(71) Applicant: Se Min Oh, Seoul (KR)

(72) Inventor: Se Min Oh, Seoul (KR)

(73) Assignee: Hyundai Motor Company, Seoul (KR)

(21) Appl. No.: 14/477,391

(22) Filed: Sep. 4, 2014

(30) Foreign Application Priority Data
Dec. 10, 2013 (KR) 10-2013-0153275

(51) Int. Cl. B60R 11/02; G05G 1/02; B60R 16/023

(52) U.S. Cl. CPC B60R 11/0264; B60R 16/0238; G05G 1/025

(57) ABSTRACT

A remote system for controlling a vehicle device includes: a device provided in a vehicle; a input signal receiver that receives a input signal for remotely controlling the device from a user of the vehicle, remotely provided from the device; a input signal determiner that analyzes the input signal, determines a control method of the device, and generates a control signal according to the determined control method, remotely provided in the vehicle from the device; and a communication unit that transfers the control signal to the device.

### CROSS-REFERENCE TO RELATED APPLICATION

This application is based on and claims under 35 U.S.C. §119(a) priority from Korean Patent Application No. 10-2013-0153275, filed on Dec. 10, 2013 in the Korean Intellectual Property Office, the disclosure of which is incorporated herein in its entirety by reference.

### BACKGROUND

(a) Field of the Invention

The present invention relates to a remote system and method for controlling a vehicle device, and more particularly, to a remote system and method for controlling a vehicle device which determines a control operation on the basis of the actual time inputting a button.

(b) Description of the Related Art

In recent years, in addition to devices required for running a vehicle such as an engine, the vehicle is equipped with various devices for providing all kinds of convenience. For example, an in-vehicle multimedia system including a car audio/video system and car DVD (Digital Versatile Disk) system, etc. may be provided inside of a vehicle. Also, the multimedia system may be customized to suit the particular vehicle.

In particular, in order to provide a higher comfort to a user when operating such a multimedia system, a steering remote controller, provided on a steering wheel of a vehicle to remotely control the multimedia system as well as to operate through the button provided on the multimedia system itself, has been developed. Generally, the steering remote controller is operated by using a voltage distribution scheme. Because all buttons for controlling the multimedia system cannot be provided in the limited space of the steering wheel, even the same control key controls the multimedia system in a different way according to the inputted method (for example, press time, whether a double click is inputted, etc.). Concretely, it controls the multimedia system by classifying a long key long-pressing the button provided in the wheel and a short key short-pressing the button.

Generally, in case of a steering remote controller, the press signal itself, in which a button is pressed, is transferred to the multimedia system of a vehicle, and the multimedia system is controlled after the multimedia system analyzes the transferred press signal and determines whether it corresponds to a long key or a short key. In this manner, since the press signal is transferred through CAN to the multimedia system, it is likely to generate an error of time measurement due to the communication delay and chattering time of CAN communication itself.

### SUMMARY

An object of the present invention is to provide a remote system for controlling a vehicle device to prevent error due to communication delay inside a vehicle or a communication error for a button input of a user.

Another object of the present invention is to provide a remote system for controlling a vehicle device in which one button receives a plurality of control methods for the in-vehicle device.

A remote system for controlling a vehicle device according to an embodiment of the present invention comprises a device provided in a vehicle; a input signal receiver configured to receive a input signal for remotely controlling the device from a user of the vehicle, remotely provided from the device; a input signal determiner configured to analyze the input signal, determine a control method of the device and generate a control signal according to the determined control method, remotely provided in the vehicle from the device; and a communication unit configured to transfer the control signal to the device.

According to an embodiment of the present invention, the device is a multimedia system providing a multimedia service to a user, the input signal receiver is a steering wheel remote controller remotely provided in a steering wheel of the vehicle from the multimedia system, the input signal determiner is provided in the steering wheel adjacent to the input signal receiver.

According to an embodiment of the present invention, the communication unit transfers the control signal through CAN communication to the multimedia system.

According to an embodiment of the present invention, the input signal determiner determines whether it is a long key input or a short key input according to the time which the button provided in the steering wheel remote controller is pressed by the user.

According to an embodiment of the present invention, the input signal determiner compares a preset reference time with the time which the button is pressed by the user, and determines it as a long key input if the pressed time is longer than the preset reference time and determines it as a short key input if the pressed time is shorter than the preset reference time.

According to an embodiment of the present invention, the multimedia system is operated in response to the control signal received through the communication unit.

The remote system according to the present invention can prevent the error due to the communication delay inside a vehicle or a communication error for a button input of a user.

Also, one button can exactly receive a plurality of control methods for the in-vehicle device.

A method for remotely controlling a vehicle device can include steps of: providing a device in a vehicle; receiving, by an input signal receiver, an input signal for remotely controlling the device from a user of the vehicle; analyzing, by an input signal determiner, the input signal so as to determine a control method of the device and generate a control signal according to the determined control method; and transferring, by a control unit, the control signal to the device.

A non-transitory computer readable medium containing program instructions executed by a processor on a controller can include: program instructions that receive an input signal for remotely controlling a device, provided in a vehicle, from a user of the vehicle; program instructions that analyze the input signal so as to determine a control method of the device and generate a control signal according to the determined control method; and program instructions that transfer the control signal to the device.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic diagram showing the data flow of a steering wheel remote controller and a multimedia system as a target device.

FIG. 2 is a diagram showing an operation process of a general steering wheel remote controller.

FIG. 3 is a diagram showing a remote system for controlling a vehicle device according to an embodiment of the present invention.

FIG. 4 is a diagram concretely showing an example which a remote system for controlling a vehicle device according to an embodiment of the present invention is applied to a steering wheel remote controller.

### DETAILED DESCRIPTION OF THE PREFERRED EMBODIMENTS

The advantage and features of the present invention and how to achieve it will be explained through embodiments described in detail with the accompanying drawings However, the invention is not limited to embodiments described herein and may be embodied in other aspects. Only, the present embodiment is provided for explaining to those skilled in the art to which this invention pertains in detail to the extent that it is possible to easily embody the technical spirit of the present invention.

In the drawings, embodiments of the present invention are not limited to the shown specific aspects and are exaggerated in order to clarify. Although specific terms are used herein, it is only used for explaining the present invention, and it is not used for limiting the meaning or the scope of the present invention described in the claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, with reference to the drawings an embodiment of the present invention will be described in detail.

A vehicle has been equipped with various devices for providing all kinds of convenience to a user. These devices may include a multimedia system providing a multimedia service to a user, a cruise device to enable running at a constant speed and the like. For convenience of description, a multimedia system (e.g., including several devices for convenience) which is provided in a vehicle is described as a specific example. However, the scope of the invention is not limited to the remote control of a multimedia system.

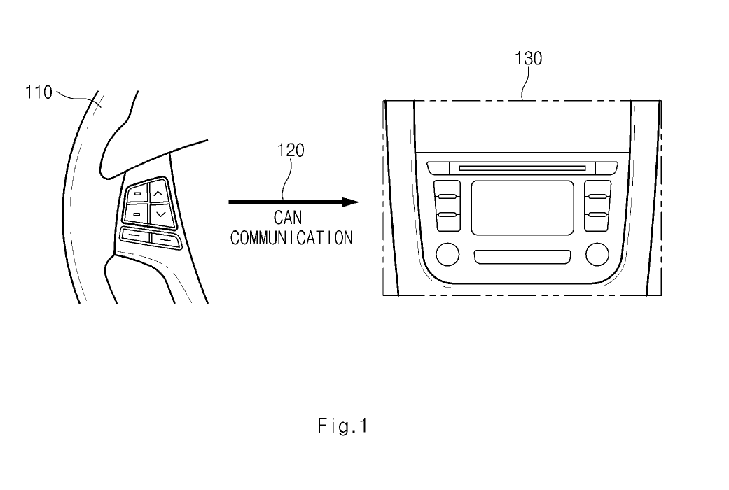

FIG. 1 is a schematic diagram showing the data flow of a steering wheel remote controller and a multimedia system as a target device.

Although a user may use a control key and a button provided in or on the multimedia system itself for controlling the multimedia system 130, a driver driving a vehicle may control (operate) the multimedia system 130 through an input key (button) included in a steering wheel remote controller 110 provided in a steering wheel to help promote safe driving and convenience.

Generally, the input signal, which is inputted by operating the button provided in the steering wheel remote controller 110 by the driver (or other vehicle occupant), is transferred through CAN communication 120 of the vehicle to the multimedia system 130 which is the control target, and the multimedia system 130 analyzes the received input signal and performs the control operation corresponding to it.

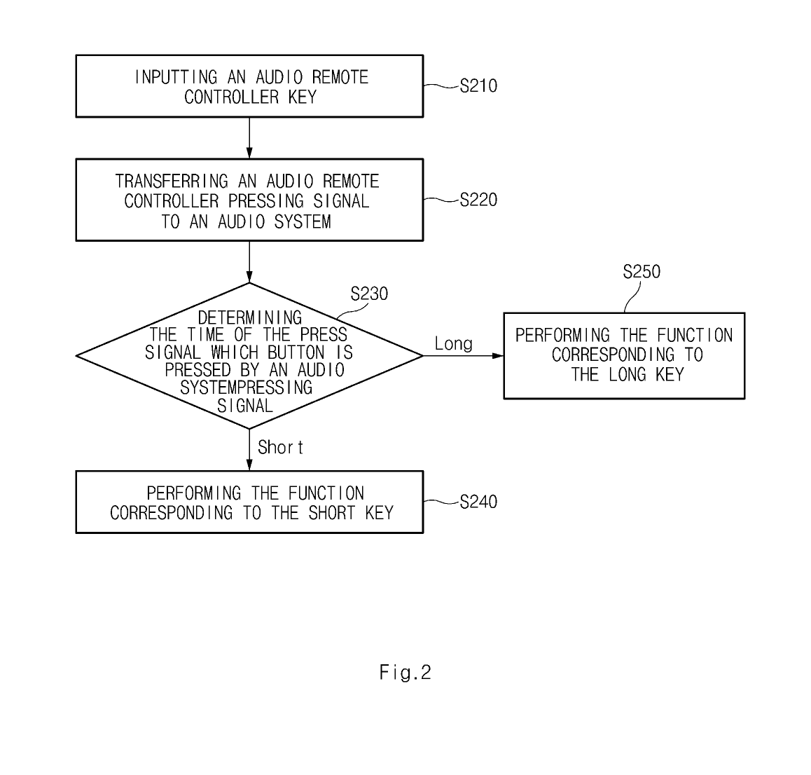

FIG. 2 is a diagram showing an operation process of a general steering wheel remote controller.

If a user inputs an input signal through the button provided in a steering wheel remote controller S210, the steering wheel remote controller transfers the press signal, corresponding to pressing of the button, to the multimedia system (audio system) S220. The audio system determines the time of the press signal which the button is pressed S230. As a result of the determination, in case of a long key, the audio system performs the function corresponding to the long key S250, and in case of a short key, the audio system performs the function corresponding to the short key S240.

The physical distance performed by CAN communication 120, which is a communication method transferring the press signal to the audio system, is short, but the error for the exact time measurement of the input signal due to communication delay and chattering time of CAN communication 120 itself may be generated. For example, if the user presses the button during 0.8 seconds in order to control the multimedia system 130, the multimedia system may receive the signal during just 0.7 seconds due to the delay of CAN communication. In particular, if the guideline determining whether it is a long key or a short key is more than 0.8 seconds, the user determines that the signal he or she inputted is the long key, but actually the multimedia system 130 may determine that the short key is inputted and perform the operation corresponding to the short key. In this case, the user must input the signal corresponding to the long key again for operating the multimedia system 130 as intended by himself.

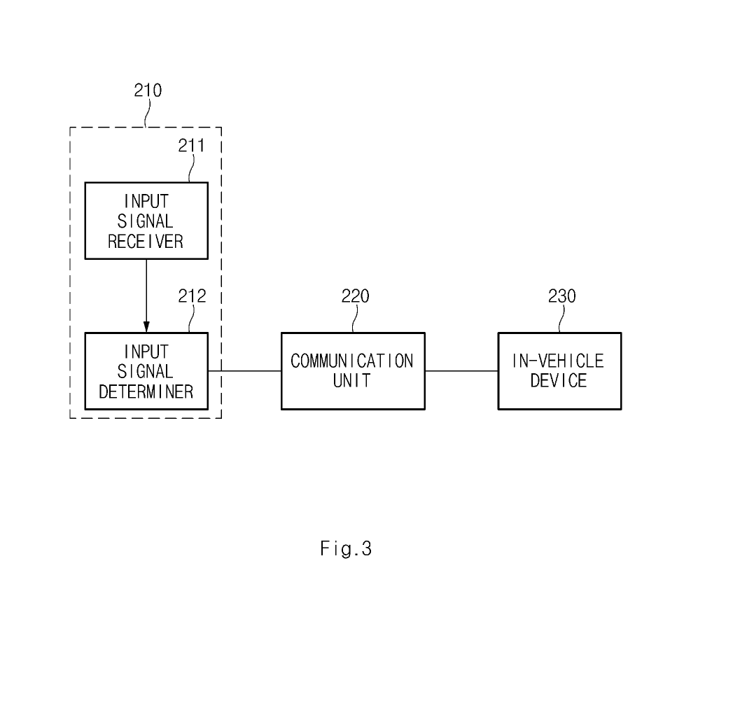

FIG. 3 is a diagram showing a remote system for controlling a vehicle device according to an embodiment of the present invention. Referring to FIG. 3, the remote system for controlling the vehicle device includes an in-vehicle device 230, an input signal receiver 211, an input signal determiner 212 and a communication unit 220.

The input signal receiver 211 is remotely provided in the vehicle from the in-vehicle device 230, and receives the input signal for remotely controlling the in-vehicle device 230 from the user of the vehicle. The received signal is transferred to the input signal determiner 212. The input signal receiver 211 may be the steering wheel remote controller remotely provided in the steering wheel of the vehicle from the in-vehicle device 230. As provided herein, the input signal receiver 211 is located remotely from (i.e., spaced apart from) the in-vehicle device 230, such that the input signal receiver 211 may be provided in a different part of the vehicle as compared to the in-vehicle device 230.

The input signal determiner 212 like the input signal receiver 211 is remotely provided in the vehicle from the in-vehicle device 230, and analyzes the input signal transferred from the input signal receiver 211, determines the control method of the in-vehicle device 230, generates the control signal depending on the determined control method, and transfers it to the communication unit 220. In particular, the input signal determiner 212 may be provided in the steering wheel adjacent to the input signal receiver 211. Also, the input signal determiner 212 may determine whether it is a long key or a short key according to the time (i.e., the duration of time) which the button provided in the steering wheel remote controller is pressed by a user.

The method which the input signal determiner 212 determines whether the button provided in the steering wheel remote controller is operated as a long key or as a short key is specifically as follows. For example, by comparing the reference time preset in the input signal determiner 212 with the time which the button is pressed by a user, if the pressed time is longer than the preset reference time, the input is determined as a long key input. Conversely, the pressed time is shorter than the preset reference time, the input is determined as a short key input.

The communication unit 220 transfers the control signal generated and transferred from the input signal determiner 212 to the in-vehicle device 230. In particular, the communication unit 220 may transfer the control signal through CAN communication to the in-vehicle device 230.

The in-vehicle device performs the operation according to the control signal transferred through the communication unit 220. In particular, the in-vehicle 230 may be a multimedia system providing a multimedia service to a user.

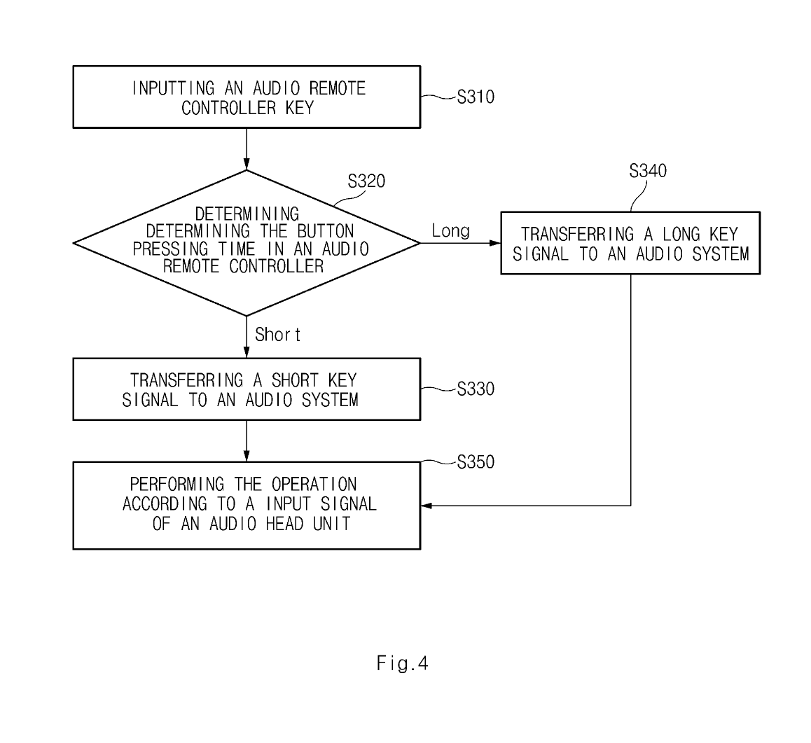

FIG. 4 is a diagram concretely showing an example which a remote system for controlling a vehicle device according to an embodiment of the present invention is applied to a steering wheel remote controller.

A user inputs an input signal through the button (remote controller key) provided in a wheel remote controller S310. In the remote system for controlling a vehicle device according to the present invention, unlike the description of FIG. 2, a steering wheel remote controller do not transfer the press signal, which the corresponding button is pressed, to a multimedia system (audio system), and determiner, provided in the steering wheel remote controller itself or closely provided in it, determines the time of the press signal which the corresponding button is pressed by itself S320. As a result of the determination, in case of long key, the steering wheel remote controller (or neighboring input signal determiner) generates the long key control signal corresponding to the long key and transfers the generated long key control signal to the multimedia system (audio system) S340, and in case of short key, the steering wheel remote controller (or neighboring input signal determiner) generates the short key control signal corresponding to the short key and transfers the generated short key control signal to the multimedia system (audio system) S330. And, the multimedia system performs the operation according to the received input signal (long key control signal or short key control signal) S350.

As described above, a remote system for controlling a vehicle device according to the present invention determines the input signal of the vehicle user through the input signal determiner provided adjacent to the input receiver (steering wheel remote controller), and transfers the control signal according to the determined result through the communication unit (CAN communication) to the in-vehicle device (multimedia system). As a result, it may prevent the in-vehicle device from performing the operation different from the input as intended by a user due to the communication error depending on the communication delay generated in a general remote system. In addition, hereafter the in-vehicle device is diversified and even though it is needed to discriminate various control signals by a certain number of buttons, exactly controlling as intended by a user is possible.

In the above description, the present invention has been described through specific examples, but it may be well understood that various modifications can be made without departing from the scope of the present invention. Therefore, the scope of the present invention is not limited to the above described embodiments, and it should be defined by the appended claims and their equivalents. When taking the foregoing description into account, if the modifications and variations of the present invention fall within the following claims and their equivalents, then it is construed that the present invention includes these modifications and variations.

What is claimed is:

1. A remote system for controlling a vehicle device, comprising:
a device provided in a vehicle;
an input signal receiver configured to receive an input signal for remotely controlling the device from a user of the vehicle, remotely provided from the device;
an input signal determiner configured to analyze the input signal, determine a control method of the device and generate a control signal according to the determined control method, remotely provided in the vehicle from the device; and
a communication unit configured to transfer the control signal to the device.

2. The remote system according to claim 1, wherein the device is a multimedia system providing a multimedia service to the user, the input signal receiver is a steering wheel remote controller remotely provided in a steering wheel of the vehicle from the multimedia system, and the input signal determiner is provided in the steering wheel adjacent to the input signal receiver.

3. The remote system according to claim 2, wherein the communication unit transfers the control signal through CAN communication to the multimedia system.

4. The remote system according to claim 2, wherein the input signal determiner determines whether it is a long key input or a short key input according to the time which the button provided in the steering wheel remote controller is pressed by the user.

5. The remote system according to claim 4, wherein the input signal determiner compares a preset reference time with the time which the button is pressed by the user, and determines it as a long key input if the pressed time is longer than the preset reference time and determines it as a short key input if the pressed time is shorter than the preset reference time.

6. The remote system according to claim 2, wherein the multimedia system is operated in response to the control signal received through the communication unit

7. A method for remotely controlling a vehicle device, comprising:
providing a device in a vehicle;
receiving, by an input signal receiver, an input signal for remotely controlling the device from a user of the vehicle;
analyzing, by an input signal determiner, the input signal so as to determine a control method of the device and generate a control signal according to the determined control method; and
transferring, by a control unit, the control signal to the device.

8. The method according to claim 7, wherein the device is a multimedia system providing a multimedia service to the user, the input signal receiver is a steering wheel remote controller remotely provided in a steering wheel of the vehicle from the multimedia system, and the input signal determiner is provided in the steering wheel adjacent to the input signal receiver.

9. The method according to claim 8, wherein the communication unit transfers the control signal through CAN communication to the multimedia system.

10. The method according to claim 8, wherein the input signal determiner determines whether it is a long key input or a short key input according to the time which the button provided in the steering wheel remote controller is pressed by the user.

11. The method according to claim 10, including:
comparing a preset reference time with the time which the button is pressed by the user, and determining it as a long key input if the pressed time is longer than the preset reference time and determining it as a short key input if the pressed time is shorter than the preset reference time.

12. The method according to claim 7, wherein the multimedia system is operated in response to the control signal received through the communication unit

13. A non-transitory computer readable medium containing program instructions executed by a processor on a controller, the computer readable medium comprising:
program instructions that receive an input signal for remotely controlling a device, provided in a vehicle, from a user of the vehicle;
program instructions that analyze the input signal so as to determine a control method of the device and generate a control signal according to the determined control method; and
program instructions that transfer the control signal to the device.
